(19) United States
(12) Patent Application Publication
(10) Pub. No.: US 2025/0296638 A1
(43) Pub. Date: Sep. 25, 2025

(54) VEHICLE FRONT BODY REINFORCEMENT STRUCTURE

(71) Applicant: TOYOTA JIDOSHA KABUSHIKI KAISHA, Toyota-shi (JP)

(72) Inventors: Yuma FURUTA, Toyota-shi (JP); Takayoshi SHIGIHARA, Toyota-shi (JP)

(73) Assignee: TOYOTA JIDOSHA KABUSHIKI KAISHA, Toyota-shi (JP)

(21) Appl. No.: 19/019,811

(22) Filed: Jan. 14, 2025

(30) Foreign Application Priority Data
Mar. 21, 2024 (JP) 2024-045514

(51) Int. Cl. B62D 25/08

(52) U.S. Cl. CPC B62D 25/088; B62D 25/084

(57) ABSTRACT

The vehicle includes: a front reinforcement portion that connects the upper portions of the suspension tower portions in the vehicle width direction; a rear reinforcement portion that extends in the vehicle width direction and is disposed along a cowl portion located on the vehicle rear side of the suspension tower portions and is connected to the cowl portion; and a vehicle body reinforcement portion that is integrally provided with the front reinforcement portion and the rear reinforcement portion, connects the front reinforcement portion and the rear reinforcement portion, and includes a pair of outer reinforcement portions that are spaced apart from each other in the vehicle width direction.

### CROSS-REFERENCE TO RELATED APPLICATION

This application claims priority to Japanese Patent Application No. 2024-045514 filed on Mar. 21, 2024, incorporated herein by reference in its entirety.

### BACKGROUND

### 1. Technical Field

The present disclosure relates to a vehicle front body reinforcement structure.

### 2. Description of Related Art

Japanese Unexamined Patent Application Publication No. 2007-145129 (JP 2007-145129 A) discloses an disclosure related to a vehicle front body structure. In the vehicle front body structure, a peripheral portion of a suspension tower portion in a vehicle body is reinforced by having a pair of suspension tower portions connected by a tower bar.

### SUMMARY

However, in the prior art, while the periphery of a cowl portion is reinforced by having an end portion of the cowl portion and the tower bar connected by a pipe material, the configuration leads to an increase in the number of components.

The present disclosure takes into consideration the circumstances, and has an objective to obtain a vehicle front body reinforcement structure that can reinforce a peripheral portion of a suspension tower portion and a peripheral portion of a cowl portion in a vehicle body, and can reduce the number of components relating to reinforcement of the vehicle body.

A vehicle front body reinforcement structure relating to a first aspect has a vehicle body reinforcement portion that includes a front reinforcement portion that connects upper portions of respective suspension tower portions to each other in a vehicle width direction, a rear reinforcement portion that extends in the vehicle width direction and is disposed along a cowl portion positioned behind the suspension tower portions in a vehicle front rear direction, the rear reinforcement portion being connected to the cowl portion, and a pair of outer reinforcement portions integrally provided with the front reinforcement portion and the rear reinforcement portion and connecting the front reinforcement portion and the rear reinforcement portion, the outer reinforcement portions being disposed spaced apart from each other in the vehicle width direction.

According to the vehicle front body reinforcement structure relating to the first aspect, a vehicle body reinforcement portion is provided that is formed from a front reinforcement portion, a rear reinforcement portion, and a pair of outer reinforcement portions.

In more detail, the front reinforcement portion connects upper portions of respective suspension tower portions to each other in a vehicle width direction, and contributes to an improvement in roll rigidity or the like of the suspension tower portions and peripheral portions of the suspension tower portions in the vehicle body.

Moreover, since the rear reinforcement portion extends in the vehicle width direction, is disposed along a cowl portion positioned behind the suspension tower portions in a vehicle front rear direction, and is connected to the cowl portion, the rear reinforcement portion contributes to an improvement in rigidity or the like against bending of the cowl portion.

Also, the pair of outer reinforcement portions is integrally provided with the front reinforcement portion and the rear reinforcement portion, the outer reinforcement portions are disposed spaced apart from each other in the vehicle width direction, and the outer reinforcement portions connect the front reinforcement portion and the rear reinforcement portion. Therefore, a load acting on the cowl portion and a peripheral portion of the cowl portion can be distributed to the front reinforcement portion and the suspension tower portion side of the vehicle body through the outer reinforcement portions.

Therefore, in the present aspect, the rigidity of the peripheral portion of the suspension tower portion and the peripheral portion of the cowl portion can be secured by one component, namely, the vehicle body reinforcement portion.

A vehicle front body reinforcement structure relating to a second aspect has, in the vehicle body reinforcement structure relating to the first aspect, the vehicle body reinforcement portion formed of a pressed steel plate.

According to the vehicle front body reinforcement structure relating to the second aspect, since the vehicle body reinforcement portion can be formed by having a steel sheet pressed, the manufacturing process of the vehicle body can be simplified.

A vehicle front body reinforcement structure relating to a third aspect has, in the vehicle front body reinforcement structure relating to the first aspect, the vehicle body reinforcement portion formed of a metal cast product.

According to the vehicle front body reinforcement structure relating to the third aspect, since the vehicle body reinforcement portion is formed of a metal cast product, vibrations transmitted from the suspension tower portion and the cowl portion can be further absorbed compared to a configuration in which the vehicle body reinforcement portion is formed of a steel plate.

A vehicle front body reinforcement structure relating to a fourth aspect has, in the vehicle front body reinforcement structure relating to the first aspect, a support member of a steering device connected to a connection portion with the cowl portion in the rear reinforcement portion.

According to the vehicle front body reinforcement structure relating to the fourth aspect, a support member of a steering device is connected at a connection portion with the cowl portion in the rear reinforcement portion of the vehicle body reinforcement portion. Accordingly, a steering input to the steering device can be supported by the vehicle body reinforcement portion through the support member, and as a result, a steering reaction force with respect to the steering input can be secured.

A vehicle front body reinforcement structure according to a fifth aspect has, in the vehicle front body reinforcement structure relating to any one of the first to fifth aspects, a cooling module supported by the vehicle body reinforcement portion.

According to the vehicle front body reinforcement structure relating to the fifth aspect, a cooling module can be supported by the vehicle body reinforcement portion, and the number of components can be reduced compared to a configuration in which a component that supports the cooling module is separately provided.

As explained, the vehicle front body reinforcement structure relating to the present disclosure has an excellent effect in which a peripheral portion of a suspension tower portion and a peripheral portion of a cowl portion in a vehicle body can be reinforced, and the number of components relating to reinforcement of the vehicle body can be reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view showing a configuration of a vehicle front side part of a vehicle to which a vehicle front body reinforcement structure according to the present embodiment is applied; and

FIG. 2 is a cross-sectional view (a cross-sectional view taken along line 1-1 of FIG. 2) showing a configuration of a portion on the vehicle front side in the vehicle to which the vehicle front body reinforcement structure according to the present embodiment is applied.

### DETAILED DESCRIPTION OF EMBODIMENTS

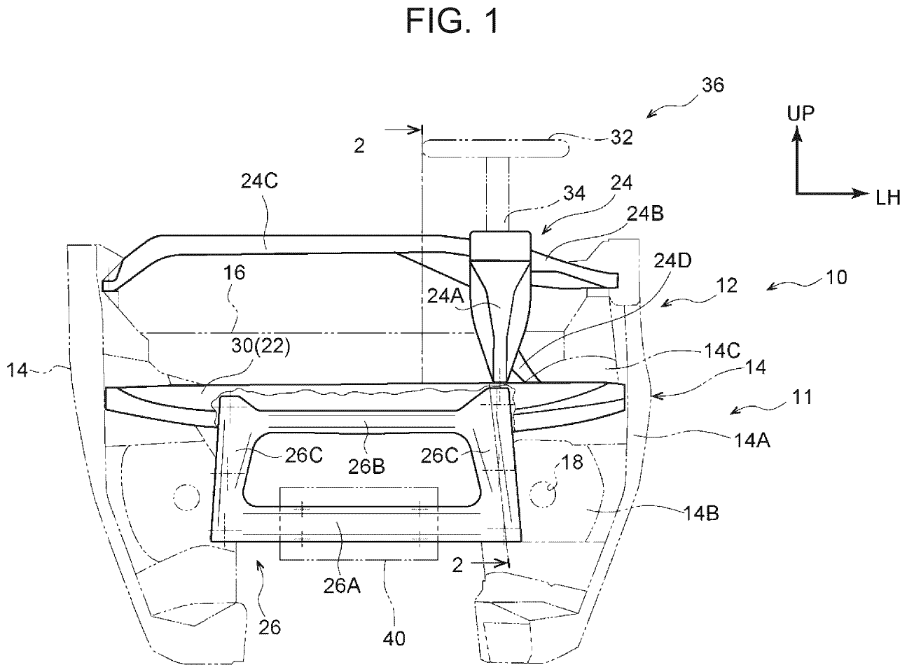

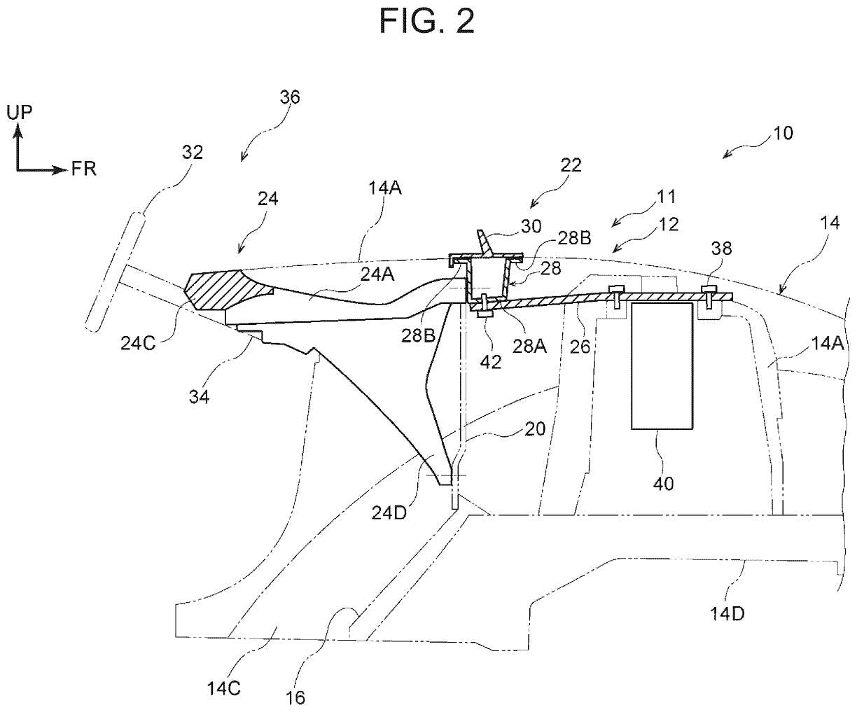

Hereinafter, an example of an embodiment of a vehicle front body reinforcement structure according to the present disclosure will be described with reference to FIG. 1 and FIG. 2. Note that an arrow FR appropriately shown in the drawings indicates the front side of the vehicle, an arrow UP indicates the upper side of the vehicle, and an arrow LH indicates the vehicle width direction left side.

First, a schematic configuration of the “vehicle 10” to which the vehicle body structure according to the present embodiment is applied will be described with reference to FIG. 1. In the present embodiment, since the vehicle 10 is basically symmetrical, the configuration of the vehicle 10 on the left side in the vehicle width direction will be mainly described below, and the configuration of the vehicle width direction on the right side will not be described as appropriate.

The vehicle body 11 of the vehicle 10 includes a front part 12 made of aluminum die-cast constituting a part on the front side of the vehicle. In addition, a center part (not shown) including a battery frame that constitutes the center portion in the vehicle front-rear direction and holds the battery and the battery is provided. Further, a rear part (not shown) made of aluminum die-cast is included in the vehicle rear side.

As also shown in FIG. 2, the front part 12 includes a pair of side components 14 and a connecting portion 16 that connects the side components 14 to each other in the vehicle width direction.

Specifically, the side components 14 each include an apron upper member portion 14A, a “suspension tower portion 14B”, a wheel house portion 14C, and a side member portion 14D.

The apron upper member portion 14A constitutes an upper edge portion of the side component 14 and extends in the front-rear direction of the vehicle. A suspension tower portion 14B and a wheel house portion 14C are provided below the apron upper member portion 14A in series with the apron upper member portion 14A.

The suspension tower portion 14B has a box shape in which a lower side of the vehicle is opened and a circular through portion 18 is formed on an upper surface thereof, and supports a shock absorber (not shown).

The wheel house portion 14C is provided integrally with the suspension tower portion 14B and has a spherical shape capable of accommodating a part of a tire (not shown).

The side member portion 14D is disposed on the vehicle lower side of the suspension tower portion 14B and is integrally provided with the suspension tower portion 14B and the wheel house portion 14C, and extends in the vehicle front-rear direction.

A crash box (not shown) is attached to the front side of the side member portion 14D.

On the other hand, the connecting portion 16 extends in the vehicle vertical direction and the vehicle width direction with the thickness direction being the vehicle front-rear direction, and is disposed along the front edge portion of the above-described center part. The vehicle cabin 10A and the power unit room 10B are partitioned together with a dash panel 20 to be described later.

A dash panel 20, a “cowl portion 22”, an “instrument panel reinforcement 24” as a support member, and a “vehicle body reinforcement portion 26” are attached to the front part 12 configured as described above.

Specifically, the dash panel 20 has a plate shape in which the thickness direction is the vehicle front-rear direction and extends in the vehicle width direction and the vehicle up-down direction, and is formed of a steel plate or the like that is press-processed. The dash panel 20 is attached to the front part 12 by an attachment member (not shown).

The cowl portion 22 extends in the vehicle width direction along the upper edge portion of the dash panel 20, and includes a cowl lower panel 28 made of steel, which constitutes a portion on the vehicle lower side, and a cowl top panel 30 made of resin, which constitutes a portion on the vehicle upper side.

The cowl lower panel 28 includes a main body portion 28A which constitutes a main portion thereof and has a U-shape in which the vehicle upper side is opened, and a flanged portion 28B which extends from an upper edge portion of the main body portion 28A to each of the vehicle front side and the vehicle rear side. The cowl lower panel 28 is attached to the pair of side components 14 via an attachment member (not shown) in a state of being bridged between them. The cowl top panel 30 covers the vehicle upper side of the cowl lower panel 28.

The instrument panel reinforcement 24 is made of plastic and includes a support portion 24A, an extension portion 24B, an extension portion 24C, and an extension portion 24D.

The support portion 24A supports a “steering device 36” including a steering wheel 32 and a steering column 34. An end portion of the vehicle front side is attached to a portion of the main body portion 28A of the cowl lower panel 28 on the vehicle rear side via an attachment member (not shown).

The extension portion 24B extends from the support portion 24A to the left side in the vehicle width direction, and a distal end portion thereof is attached to the side component 14 on the left side in the vehicle width direction by an attachment member (not shown).

The extension portion 24C extends from the support portion 24A to the right side in the vehicle width direction, and a distal end portion thereof is attached to the side component 14 on the right side in the vehicle width direction by an attachment member (not shown).

The extension portion 24D extends from the support portion 24A toward the lower side of the vehicle, and a distal end portion thereof is attached to the dash panel 20 by an attachment member (not shown).

On the other hand, the vehicle body reinforcement portion 26 is formed of a pressed steel plate, and has a trapezoidal frame shape that includes a “front reinforcement portion 26A”, a “rear reinforcement portion 26B”, and a pair of “outer reinforcement portions 26C”, and is widened from the vehicle rear side to the vehicle front side when viewed from the vehicle vertical direction.

More specifically, the front reinforcement portion 26A extends in the vehicle width direction, and has a hat shape in which a cross-sectional shape viewed from the vehicle width direction in the main part thereof is an open hat shape on the vehicle lower side. The end portions of the front reinforcement portion 26A are respectively attached to the upper portions of the suspension tower portions 14B by attachment members 38, and the upper portions of the pair of suspension tower portions 14B are connected to each other by the front reinforcement portion 26A in a vehicle width direction.

Further, a “cooling module 40” for cooling the coolant for cooling the battery of the center part is disposed on the vehicle lower side of the front reinforcement portion 26A, and the cooling module 38 is attached to the front reinforcement portion 26A by a mounting member (not shown).

The rear reinforcement portion 26B extends in the vehicle width direction, and has a hat shape in which a cross-sectional shape viewed from the vehicle width direction in a main part thereof is an open hat shape on the vehicle lower side. The rear reinforcement portion 26B is disposed along the cowl portion 22 on the vehicle lower side of the cowl portion 22. The rear reinforcement portion 26B is attached to a part of the cowl lower panel 28 on the main body portion 28A on the vehicle-lower side at a plurality of positions by the attachment member 42.

The connection portion on the left side in the vehicle width direction among the connection portions between the rear reinforcement portion 26B and the cowl lower panel 28 is located in the vicinity of the connection portion between the instrument panel reinforcement 24 and the cowl lower panel 28.

The outer reinforcement portion 26C has a hat shape in which a cross-sectional shape viewed from the vehicle front-rear direction is an open hat shape in the main portion, and connects the front reinforcement portion 26A and the rear reinforcement portion 26B, and is spaced apart from each other in the vehicle widthwise direction.

In the present embodiment, the steering device 36 is disposed on the left side in the vehicle width direction, and the vehicle 10 is a so-called left steering vehicle, but the steering device 36 may be disposed on the right side in the vehicle width direction. That is, the vehicle front body reinforcement structure according to the present embodiment can also be applied to a vehicle having a right steering wheel.

### Actions and Effects of Embodiment

Next, actions and effects of the embodiment will be described.

In the present embodiment, as shown in FIG. 1, a vehicle body reinforcement portion 26 including a front reinforcement portion 26A, a rear reinforcement portion 26B, and a pair of outer reinforcement portions 26C is provided.

Specifically, the front reinforcement portion 26A connects the upper portions of the suspension tower portion 14B to each other in the vehicle widthwise direction, and contributes to improvement in the suspension tower portion 14B of the vehicle body 11, the roll stiffness of the peripheral portion thereof, and the like. Accordingly, in the present embodiment, it is possible to adapt to the thinning of the upper portion of the apron upper member portion 14A and the suspension tower portion 14B due to the decrease in the vehicle height of the vehicle 10.

Further, the rear reinforcement portion 26B extends in the vehicle widthwise direction, and is disposed along the cowl portion 22 located on the vehicle rear side of the suspension tower portion 14B and is connected to the cowl portion 22, and thus contributes to improvement of the rigidity against bending of the cowl portion 22 and the like. Thus, in the present embodiment, it is possible to reduce the thickness of the components such as the cowl lower panel 28 constituting the cowl portion 22.

The pair of outer reinforcement portions 26C is integrally provided with the front reinforcement portion 26A and the rear reinforcement portion 26B and are spaced apart from each other in the vehicle width direction, and connect the front reinforcement portion 26A and the rear reinforcement portion 26B. Therefore, the load acting on the cowl portion 22 and the peripheral portion thereof can be distributed through the outer reinforcement portions 26C to the front reinforcement portion 26A and thus to the suspension tower portion 14B side of the vehicle body 11.

Therefore, in the present embodiment, the rigidity of the peripheral portion of the suspension tower portion 14B and the peripheral portion of the cowl portion 22 can be secured by one component, that is, the vehicle body reinforcement portion 26.

Further, in the present embodiment, since the vehicle body reinforcement portion 26 can be formed by pressing the steel sheet, the manufacturing process of the vehicle body 11 can be simplified.

Further, in the present embodiment, the instrument panel reinforcement 24 that supports the steering device 36 is connected at a connection position with the cowl portion 22 on the rear reinforcement portion 26B of the vehicle body reinforcement portion 26. Therefore, the steering input to the steering device 36 can be supported by the vehicle body reinforcement portion 26 via the instrument panel reinforcement 24, and as a result, the steering reaction force with respect to the steering input can be secured.

In addition, in the present embodiment, the cooling module 40 can be supported by the vehicle body reinforcement portion 26, and the number of components can be reduced as compared with a configuration in which a component for supporting the cooling module 40 is separately provided.

In the present embodiment, the vehicle body reinforcement portion 26 is formed of a steel plate press-processed as described above, but the vehicle body reinforcement portion 26 may be made of aluminum die cast. According to such a configuration, since the vehicle body reinforcement portion 26 is formed of a metal cast product, the vibrations transmitted from the suspension tower portion 14B and the cowl portion 22 can be more absorbed than in a configuration in which the vehicle body reinforcement portion 26 is formed of a steel plate.

As described above, according to the vehicle front body reinforcement structure of the present embodiment, the peripheral portion of the suspension tower portion 14B and the peripheral portion of the cowl portion 22 of the vehicle body 11 can be reinforced, and the number of components related to the reinforcement of the vehicle body 11 can be reduced.

What is claimed is:

1. A vehicle front body reinforcement structure comprising a vehicle body reinforcement portion that includes a front reinforcement portion that connects upper portions of respective suspension tower portions to each other in a vehicle width direction,
a rear reinforcement portion that extends in the vehicle width direction and is disposed along a cowl portion positioned behind the suspension tower portions in a vehicle front rear direction, the rear reinforcement portion being connected to the cowl portion, and
a pair of outer reinforcement portions integrally provided with the front reinforcement portion and the rear reinforcement portion and connecting the front reinforcement portion and the rear reinforcement portion, the outer reinforcement portions being disposed spaced apart from each other in the vehicle width direction.

2. The vehicle front body reinforcement structure according to claim 1, wherein the vehicle body reinforcement portion is formed of a pressed steel plate.

3. The vehicle front body reinforcement structure according to claim 1, wherein the vehicle body reinforcement portion is formed of a metal cast product.

4. The vehicle front body reinforcement structure according to claim 1, wherein a support member of a steering device is connected to a connection portion with the cowl portion in the rear reinforcement portion.

5. The vehicle front body reinforcement structure according to claim 1, wherein a cooling module is supported by the vehicle body reinforcement portion.
